(19) United States
(12) Patent Application Publication
(10) Pub. No.: US 2026/0228909 A1
(43) Pub. Date: Aug. 6, 2026

(54) IMAGE PROCESSING APPARATUS, IMAGE PROCESSING METHOD, AND PROGRAM

(71) Applicant: FUJIFILM Corporation, Tokyo (JP)

(72) Inventor: Shinji HAYASHI, Tokyo (JP)

(73) Assignee: FUJIFILM Corporation, Tokyo (JP)

(21) Appl. No.: 19/576,169

(22) Filed: Mar. 24, 2026

Related U.S. Application Data
(63) Continuation of application No. PCT/JP2024/030213, filed on Aug. 26, 2024.

(30) Foreign Application Priority Data
Sep. 25, 2023 (JP) 2023-160127

(51) Int. Cl. G06T 7/70; G06T 5/50; G06T 7/11; G06T 7/13; G06T 7/33; G06V 20/17

(52) U.S. Cl. CPC G06T 7/70; G06T 5/50; G06T 7/11; G06T 7/13; G06T 7/33; G06V 20/17; G06T 2207/20221; G06V 2201/07

(57) ABSTRACT

An image processing apparatus which sets a ground control point in an image without installation of an aerial target marker and setting of a GCP by a person. The image processing apparatus includes one or more processors and one or more memories that store a program to be executed by the one or more processors. The processor is configured to execute a command of the program to acquire an image group in which a certain imaging region is imaged by using a camera, select a setting image for setting a ground control point from the image group, specify a map corresponding to an imaging region of the setting image, specify a target object for setting the ground control point from the map, search for a candidate position corresponding to a position of the target object from the setting image, and set the candidate position as the ground control point.

### CROSS-REFERENCE TO RELATED APPLICATIONS

The present application is a Continuation of PCT International Application No. PCT/JP 2024/030213 filed on Aug. 26, 2024 claiming priority under 35 U.S. C § 119(a) to Japanese Patent Application No. 2023-160127 filed on Sep. 25, 2023. Each of the above applications is hereby expressly incorporated by reference, in its entirety, into the present application.

### BACKGROUND OF THE INVENTION

### 1. Field of the Invention

The present invention relates to an image processing apparatus, an image processing method, and a program, and particularly to a technique of setting a ground control point in an image.

### 2. Description of the Related Art

In recent years, a three-dimensional model generated by structure from motion (SfM) based on an image captured by a drone has been used for assessing a damage situation during disasters and for surveying during normal times.

W02023/047799A discloses an image processing technique including processing of associating an image captured by a camera mounted on a drone with a position in space of an imaging target range. According to WO2023/047799A, since the values of the parameters of the camera matrix are automatically searched for, based on the sensor data obtained from the drone, and the optimal parameter value is selected, the designation of the correspondence point by a person is not necessary, and highly accurate registration between the map data of the imaging target range and the captured image can be performed.

### SUMMARY OF THE INVENTION

In a case in which a three-dimensional model and an ortho image are generated by SfM processing from an aerial image without using a ground control point (GCP) of which a latitude and a longitude are known, when the three-dimensional model and the ortho image are superimposed on the map, a deviation of about 5 to 10 meters occurs due to an influence of a misregistration of global positioning system (GPS) information at the time of image capturing.

On the other hand, in a case in which an aerial target marker is installed at the GCP on the ground and an aerial target marker is extracted from the aerial image, it is possible to generate the three-dimensional model and the ortho image that are accurately superimposed on the map. However, there is a problem that it takes time to install the aerial target marker in a wide imaging region. In addition, a person can visually set a corresponding point as the GCP manually by visually checking the image and the map, but there is a problem that it takes time.

The present invention has been made in view of such circumstances, and an object of the present invention is to provide an image processing apparatus, an image processing method, and a program for setting a GCP in an image without performing work of installing an aerial target marker and work of setting a GCP by a person.

In order to achieve the above object, a first aspect of the present disclosure provides an image processing apparatus according to a first aspect of the present disclosure comprising: one or more processors; and one or more memories that store a program to be executed by the one or more processors, in which the processor is configured to execute a command of the program to acquire an image group in which a certain imaging region is imaged by using a camera, select a setting image for setting a ground control point from the image group, specify a map corresponding to an imaging region of the setting image, specify a target object for setting the ground control point from the map, search for a candidate position corresponding to a position of the target object from the setting image, and set the candidate position as the ground control point.

According to the first aspect, the GCP can be set in the image without performing the work of installing the aerial target marker and the work of setting the GCP by the person.

In an image processing apparatus according to a second aspect of the present disclosure, in the image processing apparatus according to the first aspect, it is preferable that the processor is configured to select a plurality of the setting images.

In an image processing apparatus according to a third aspect of the present disclosure, in the image processing apparatus according to the first or second aspect, it is preferable that the processor is configured to: divide the imaging region into a plurality of setting image selection regions each including a plurality of images; calculate the number of features in each image of the image group; and select, for each setting image selection region of the plurality of setting image selection regions, an image having a relatively large number of features among the plurality of images included in the setting image selection region as the setting image.

In an image processing apparatus according to a fourth aspect of the present disclosure, in the image processing apparatus according to any one of the first to third aspects, it is preferable that the target object is a bending point of a road.

In an image processing apparatus according to a fifth aspect of the present disclosure, in the image processing apparatus according to the fourth aspect, it is preferable that the processor is configured to: extract the bending point of the road from the map; convert the setting image into a line segment image; extract a bending point as the candidate position from the line segment image; and set the bending point of the line segment image corresponding to the bending point of the road as the ground control point.

In an image processing apparatus according to a sixth aspect of the present disclosure, in the image processing apparatus according to any one of the first to fifth aspects, it is preferable that the processor is configured to display an extraction result image in which a figure is superimposed on a position of the ground control point of the setting image on a display device.

In an image processing apparatus according to a seventh aspect of the present disclosure, in the image processing apparatus according to the sixth aspect, it is preferable that the processor is configured to display an enlarged image in which a position of the ground control point of the setting image is enlarged on the display device.

In an image processing apparatus according to an eighth aspect of the present disclosure, in the image processing apparatus according to the sixth or seventh aspect, it is preferable that the processor is configured to: display the extraction result image and a check image based on the setting image side by side on the display device; and further display a determination button for a user to determine whether or not to adopt the ground control point on the display device.

In an image processing apparatus according to a ninth aspect of the present disclosure, in the image processing apparatus according to the eighth aspect, it is preferable that the processor is configured to: calculate a reliability degree indicating how reliable the set ground control point is as the ground control point; and display the reliability degree on the display device.

In an image processing apparatus according to a tenth aspect of the present disclosure, in the image processing apparatus according to any one of the first to ninth aspects, it is preferable that the processor is configured to: calculate a reliability degree indicating how reliable the candidate position is as the ground control point; and set the candidate position as the ground control point in accordance with the reliability degree.

In an image processing apparatus according to an eleventh aspect of the present disclosure, in the image processing apparatus according to any one of the first to tenth aspects, it is preferable that the image group is captured with an overlapping region with an adjacent image, and the processor is configured to: set the ground control point set in the overlapping region as a tie point; and calculate a position and an orientation of the camera in a case in which the camera captures each image of the image group based on the tie point.

In an image processing apparatus according to a twelfth aspect of the present disclosure, in the image processing apparatus according to any one of the first to eleventh aspects, it is preferable that the processor is configured to: acquire an overall map corresponding to the certain imaging region; and perform registration between each image of the image group and the overall map by using the set ground control point.

In order to achieve the above object, a thirteenth aspect of the present disclosure provides an image processing method executed by one or more processors, the image processing method comprising: acquiring an image group in which a certain imaging region is imaged by using a camera; selecting a setting image for setting a ground control point from the image group; specifying a map corresponding to an imaging region of the setting image; specifying a target object for setting the ground control point from the map; searching for a candidate position corresponding to a position of the target object from the setting image; and setting the candidate position as the ground control point.

According to the thirteenth aspect, the GCP can be set in the image without performing the work of installing the aerial target marker and the work of setting the GCP by the person.

In order to achieve the above object, a fourteenth aspect of the present disclosure provides a program causing a computer to implement: a function of acquiring an image group in which a certain imaging region is imaged by using a camera; a function of selecting a setting image for setting a ground control point from the image group; a function of specifying a map corresponding to an imaging region of the setting image; a function of specifying a target object for setting the ground control point from the map; a function of searching for a candidate position corresponding to a position of the target object from the setting image; and a function of setting the candidate position as the ground control point.

According to the fourteenth aspect, the GCP can be set in the image without performing the work of installing the aerial target marker and the work of setting the GCP by the person.

The present disclosure also includes a non-transitory computer-readable recording medium, such as a compact disk-read only memory (CD-ROM), storing the program according to the fourteenth aspect.

According to an embodiment of the present invention, the GCP can be set in the image without performing the work of installing the aerial target marker and the work of setting the GCP by the person.

### BRIEF DESCRIPTION OF THE DRAWINGS

FIG. 1 is a schematic diagram showing a configuration example of a captured image processing system.

FIG. 2 is a block diagram schematically showing an example of an electrical configuration of a drone on which a camera is mounted.

FIG. 3 is a block diagram showing a hardware configuration example of the image processing apparatus.

FIG. 4 is a block diagram showing a functional configuration example of the image processing apparatus.

FIG. 5 is a flowchart showing each step of an image processing method according to the first embodiment.

FIG. 6 is an example of a plurality of images acquired by a captured image acquisition unit.

FIGS. 7A and 7B are diagrams showing an image included in the plurality of images and a Geospatial Information Authority of Japan map corresponding to the image.

FIG. 8 is a diagram showing the plurality of images and a calculation result of the number of buildings in each image of the plurality of images.

FIGS. 9A to 9C are diagrams for describing processing of selecting a GCP setting image.

FIG. 10 is a diagram showing an application result of geocoding of the GCP setting image.

(A) to (C) of FIG. 11 are diagrams for describing extraction of the GCP.

FIG. 12 is a diagram showing an example of a GCP check/correction screen.

FIG. 13 is a diagram showing another example of the GCP check/correction screen.

FIG. 14 is a flowchart showing each step of an image processing method according to the second embodiment.

FIGS. 15A to 15D are diagrams for describing automatic extraction of the GCP and setting of the tie point.

FIGS. 16A to 16D is diagrams for describing automatic extraction of the GCP and setting of the tie point.

### DESCRIPTION OF THE PREFERRED EMBODIMENTS

Hereinafter, preferred embodiments of the present invention will be described in detail with reference to the accompanying drawings. In the present specification, identical reference numerals are denoted by identical components, and duplicate descriptions will be omitted as appropriate.

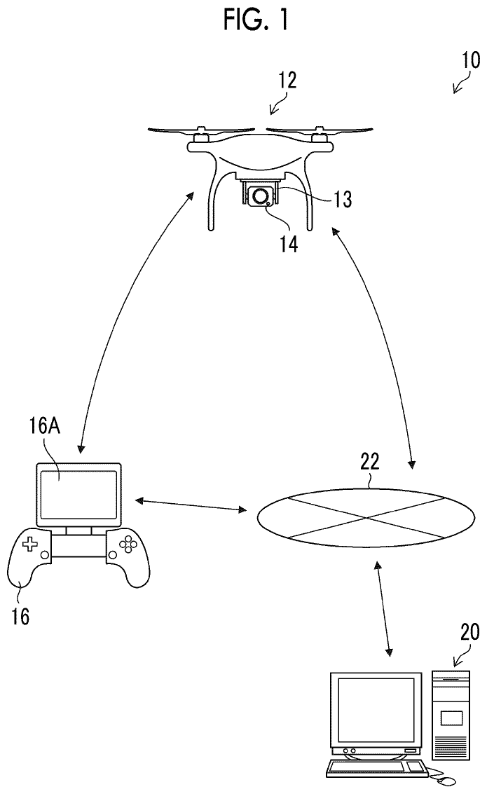

FIG. 1 is a schematic diagram showing a configuration example of a captured image processing system 10. The captured image processing system 10 includes a drone 12 for aerial imaging, a camera 14 mounted on the drone 12, a remote controller 16, and an image processing apparatus 20. The drone 12 is an unmanned aerial vehicle that is remotely operated using the remote controller 16. The drone 12 may have an auto-pilot function of flying in accordance with a program.

The camera 14 is mounted on the drone 12 via a gimbal head 13. The camera 14 includes an optical system (not shown), an image sensor, and a signal processing circuit. The optical system includes one or more lenses, such as a focus lens. The image sensor may be, for example, a charge coupled device (CCD) image sensor or a complementary metal-oxide semiconductor (CMOS) image sensor.

The camera 14 generates digital image data of an imaged target by processing a signal obtained from the image sensor by the signal processing circuit. The digital image data generated by the camera 14 can be an “image”. The image captured by using the camera 14 is stored in a storage device such as an internal storage built in the drone 12 and/or a memory card that is attachably and detachably mounted on the drone 12. In addition, the image captured by using the camera 14 may be transmitted to the remote controller 16 by using wireless communication, or may be transmitted to the image processing apparatus 20.

The remote controller 16 is a transmitter that controls operations of the camera 14 and the drone 12 via wireless communication. A form of the wireless communication may be a form of a wireless local area network (LAN). The form of the wireless communication may be a communication form using radio waves in a 2.4 GHz band or a 5.7 GHz band. The form of the wireless communication may be a form using a mobile communication network. A communication form of a control signal for controlling the drone 12 and a communication form for transmitting the image captured by using the camera 14 or the like may be different from each other or may be common to each other.

The remote controller 16 comprises a display 16A, left and right sticks (not shown) for operating a flight operation of the drone 12, a lever (not shown) for operating the gimbal head 13, an imaging button (not shown) for instructing the imaging by the camera 14, and an imaging mode button (not shown) for switching between video imaging and still image imaging.

The display 16A may be a touch panel display. Various operations on the drone 12, the gimbal head 13, and the camera 14 may be performed by a touch operation on the touch panel display. The touch operation includes a tap operation, a double tap operation, a flick operation, a swipe operation, a drag operation, a pinch-in operation, and a pinch-out operation.

A live video captured by using the camera 14 is displayed on the display 16A of the remote controller 16 or the like. In addition, the remote controller 16 ascertains a situation of an aircraft, such as a flight position and a flight speed, in real time based on data of various sensors provided in the drone 12. Flight information indicating the situation of the aircraft may be displayed on the display 16A.

The captured image processing system 10 captures a plurality of still images (captured images) from the air by using the camera 14, and processes the captured images in the image processing apparatus 20.

The image processing apparatus 20 is for automatically setting a ground control point (GCP) required for generating a high-accuracy three-dimensional model and an ortho image from an aerial image group in which images adjacent to each other have an overlap region. The GCP is a point on the ground of which a latitude, a longitude, and an elevation are known, and is a point of a characteristic terrain that is visually recognizable in the image. The image processing apparatus 20 may generate a high-accuracy three-dimensional model and an ortho image from the aerial image group.

The image processing apparatus 20 is configured by a computer. The computer applied to the image processing apparatus 20 may be a server, a personal computer, or a workstation.

The image processing apparatus 20 performs data communication with the remote controller 16 via a network 22. The network 22 may be a local area network or a wide area network. The image processing apparatus 20 acquires various types of information from the drone 12 and the camera 14. The image processing apparatus 20 acquires map data of an imaging target range from a geographical information system (not shown) via the network 22. The image processing apparatus 20 may acquire the map data in advance before the imaging by the camera 14, or may acquire the map data after the imaging by the camera 14.

### Configuration Example of Drone Equipped With Camera

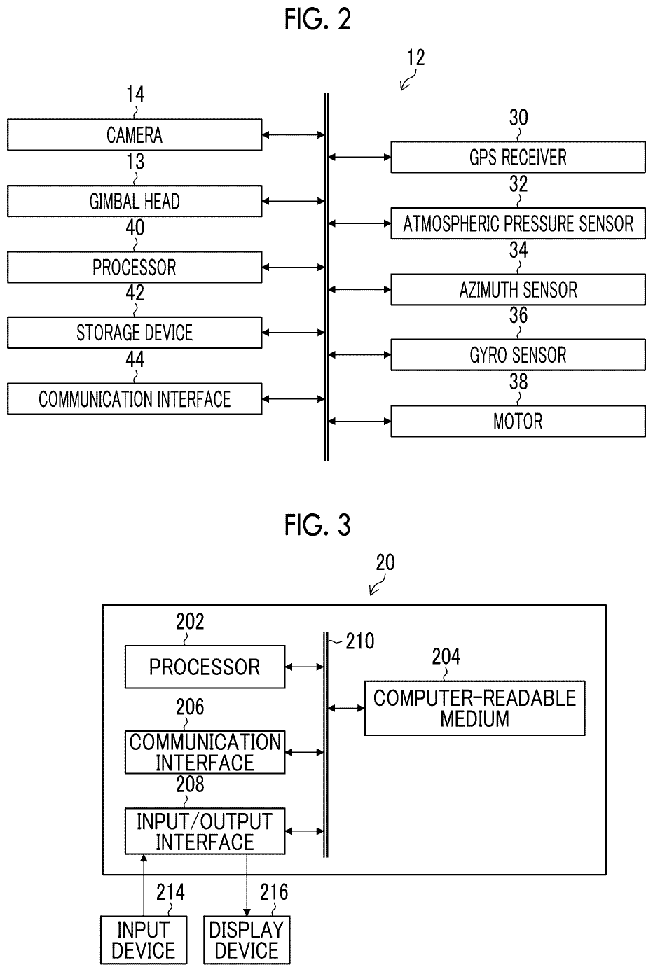

FIG. 2 is a block diagram schematically showing an example of an electrical configuration of the drone 12 on which the camera 14 is mounted. The drone 12 includes a global positioning system (GPS) receiver 30, an atmospheric pressure sensor 32, an azimuth sensor 34, a gyro sensor 36, a motor 38, a processor 40, a storage device 42, a communication interface 44, a battery (not shown), and a charging terminal of the battery.

The GPS receiver 30 acquires position information including a latitude and a longitude of a position of the drone 12. The atmospheric pressure sensor 32 detects an atmospheric pressure of the position of the drone 12. The drone 12 acquires an altitude of the position of the drone 12 based on the atmospheric pressure detected by using the atmospheric pressure sensor 32. The term “acquisition” includes the concept of generating information through data processing, such as calculation. The latitude, the longitude, and the altitude of the drone 12 constitute the position information of the drone 12 and the camera 14.

The azimuth sensor 34 may be, for example, a geomagnetic sensor. The drone 12 detects an azimuth angle in which a lens of the camera 14 faces by the azimuth sensor 34.

The gyro sensor 36 detects a roll angle indicating a rotation angle with respect to a roll axis, a pitch angle indicating a rotation angle with respect to a pitch axis, and a yaw angle indicating a rotation angle with respect to a yaw axis. The drone 12 acquires orientation information of the camera 14 based on the rotation angle acquired by using the gyro sensor 36. It should be noted that a part of or all of sensors, such as the GPS receiver 30, the atmospheric pressure sensor 32, the azimuth sensor 34, and the gyro sensor 36, may be disposed on the camera 14 side.

The motor 38 is a power source that rotates a rotary wing (rotor) (not shown). The drone 12 includes a plurality of motors 38 that drive a plurality of rotary wings.

The storage device 42 may be a memory, an internal storage, an external storage device, or a combination thereof. The processor 40 acts as a flight controller, and performs various operations necessary for flight control of the drone 12 based on sensor data obtained from various sensors.

The communication interface 44 is a communication unit that performs the wireless communication with the remote controller 16 and the like. The communication interface 44 may comprise a communication terminal corresponding to wired communication.

### Overview of Image Processing Apparatus

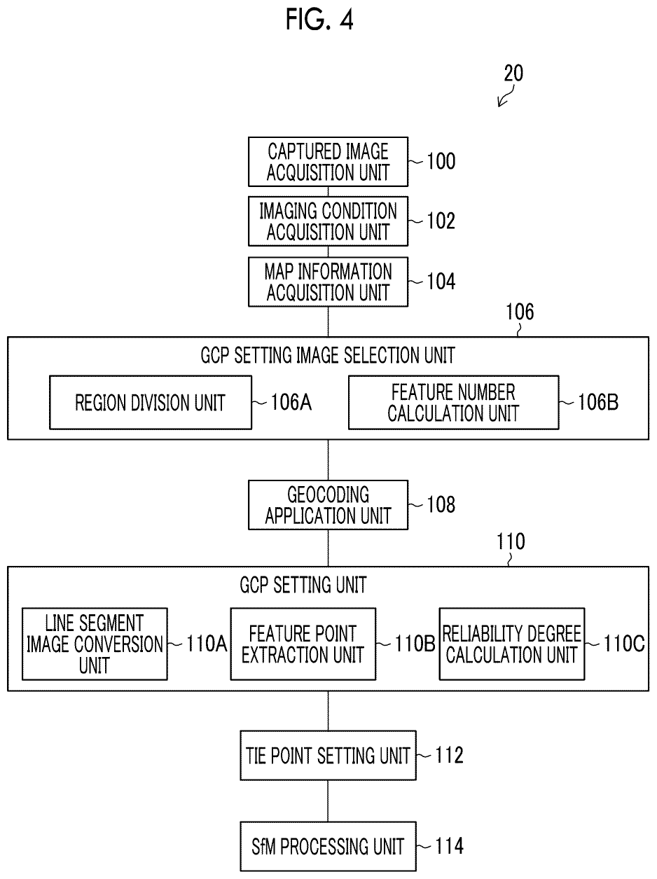

FIG. 3 is a block diagram showing a hardware configuration example of the image processing apparatus 20. The image processing apparatus 20 includes one or more processors 202, one or more computer-readable media 204, a communication interface 206, an input/output interface 208, and a bus 210.

A hardware structure of the processor 202 is various processors as described below. The various types of processors include a central processing unit (CPU) that is a general-purpose processor which acts as various types of functional units by executing software (program), a graphics processing unit (GPU) that is a processor specialized in image processing, a programmable logic device (PLD) that is a processor of which a circuit configuration is changeable after manufacture, such as a field programmable gate array (FPGA), and a dedicated electric circuit that is a processor which has a circuit configuration specifically designed in order to execute specific processing, such as an application specific integrated circuit (ASIC).

One processing unit may be configured by one of the various types of processors or may be configured by the same type or different types of two or more processors (for example, a plurality of FPGAs, a combination of a CPU and an FPGA, or a combination of a CPU and a GPU). In addition, one processor may configure a plurality of functional units. As an example of configuring a plurality of functional units by one processor, first, there is a form in which one processor is configured by a combination of one or more CPUs and software and the processor acts as the plurality of functional units, as represented by a computer such as a client and a server. Second, there is a form in which a processor that realizes functions of the entire system including a plurality of functional units with one integrated circuit (IC) chip is used, as represented by a system on chip (SoC) or the like. As described above, the various types of functional units are configured by one or more of the various types of processors used as a hardware structure.

Further, the hardware structure of the various types of processors is, more specifically, an electric circuit (circuitry) in which circuit elements such as semiconductor elements are combined.

The processor 202 is connected to the computer-readable medium 204, the communication interface 206, and the input/output interface 208 through the bus 210.

The computer-readable medium 204 stores a command to be executed by the processor 202. The computer-readable medium 204 includes a memory that is a main storage device, and a storage that is an auxiliary storage device. For example, the computer-readable medium 204 may be a semiconductor memory, a hard disk drive (HDD) device, a solid state drive (SSD) device, or a combination thereof. The computer-readable medium 204 stores various programs, data, and the like including an image processing program.

The communication interface 206 controls communication via the network 22.

The input/output interface 208 is connected to an input device 214 and a display device 216, and controls input and output to the image processing apparatus 20.

The input device 214 is configured by, for example, a keyboard, a mouse, a multi-touch panel, another pointing device, a voice input device, or an appropriate combination thereof.

The display device 216 is configured, for example, by using a liquid crystal display, an organic electro-luminescence (OEL) display, a projector, or an appropriate combination thereof.

The image processing apparatus 20 may have a configuration including the input device 214 and the display device 216.

### Functional Configuration of Image Processing Apparatus

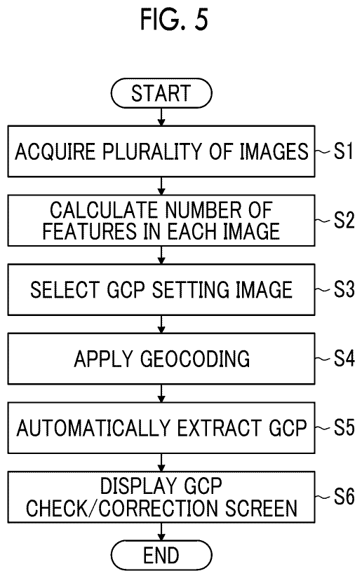

FIG. 4 is a block diagram showing a functional configuration example of the image processing apparatus 20. The image processing apparatus 20 includes a captured image acquisition unit 100, an imaging condition acquisition unit 102, a map information acquisition unit 104, a GCP setting image selection unit 106, a geocoding application unit 108, a GCP setting unit 110, a tie point setting unit 112, an SfM processing unit 114, an input reception unit 116, and a display control unit 118. Each function of the image processing apparatus 20 is materialized by the processor 202 executing the program stored in the computer-readable medium 204.

The captured image acquisition unit 100 acquires, from the camera 14, a plurality of images (an example of an “image group”) in which a certain imaging region is imaged by using the camera 14. The captured image acquisition unit 100 acquires a plurality of images in which a part of the imaging region is imaged, and the plurality of images are imaged with an overlap region (an example of an “overlapping region”) with adjacent images.

The imaging condition acquisition unit 102 acquires an imaging condition of each image of the plurality of images from the drone 12. The imaging condition includes at least one of position information including a latitude, a longitude, and an altitude of the camera 14 at the time of imaging, azimuth angle information of the lens of the camera 14, or posture information of the camera 14.

The map information acquisition unit 104 acquires map information including the imaging region of the plurality of images acquired by the captured image acquisition unit 100. The map information acquisition unit 104 may acquire the map information from the computer-readable medium 204, may acquire the map information from the input device 214, or may acquire the map information via the network 22.

The GCP setting image selection unit 106 selects a GCP setting image for setting the GCP from the plurality of images acquired by the captured image acquisition unit 100. It is preferable that the GCP setting image selection unit 106 selects a plurality of GCP setting images without bias in the imaging region of the plurality of images. In addition, it is preferable that the GCP setting image selection unit 106 selects a plurality of GCP setting images from an image in which a relatively large number of buildings are imaged.

It is known that the number of GCPs for mapping the image and the map is sufficient with 5 to 10 (see Relationship between the number of GCPs and the accuracy of drone maps [Searched Jun. 26, 2023], Internet <URL: https://www.pix4d.com/jp/blog/GCP-accuracy-drone-maps/>). Therefore, the GCP setting image selection unit 106 selects 5 to 10 GCP setting images from the plurality of images.

The GCP setting image selection unit 106 includes a region division unit 106A and a feature number calculation unit 106B. The region division unit 106A divides the imaging region imaged in the image group acquired by the captured image acquisition unit 100 into a plurality of setting image selection regions each including a plurality of images. The feature number calculation unit 106B calculates the number of features shown in each image of the image group acquired by the captured image acquisition unit 100. The feature is, for example, a building. The building is not limited to a building for a residence such as a “detached building” and an “apartment”, and may include all buildings such as a “store”, an “office”, a “school”, and a “factory”.

The GCP setting image selection unit 106 may select, for each setting image selection region of the plurality of setting image selection regions, an image having a relatively large number of features among the plurality of images included in the setting image selection region as the GCP setting image.

The geocoding application unit 108 applies geocoding to the GCP setting image selected by the GCP setting image selection unit 106, matches a line segment extracted from the image with a line segment extracted from the map, and projects a road line segment of the map onto the GCP setting image with an accuracy within an error of about 3 to 5 meters. In the present specification, the term “geocoding” refers to the registration technique described in WO2023/047799A.

The GCP setting unit 110 specifies a map corresponding to the imaging region of the GCP setting image selected by the GCP setting image selection unit 106, and specifies a target object for setting the ground control point from the map. In addition, the GCP setting unit 110 searches for a candidate position corresponding to the position of the target object specified from the setting image, and sets the candidate position as the GCP. The GCP setting unit 110 may display an extraction result image in which a figure is superimposed on a position of the GCP set in the GCP setting image on the display device 216. The GCP setting unit 110 may display an enlarged image in which the position of the set GCP of the GCP setting image is enlarged and cut out on the display device 216.

The GCP setting unit 110 may display an extraction result image in which a figure is superimposed on a position of the set GCP of the GCP setting image and a check image based on the GCP setting image side by side on the display device 216. The GCP setting unit 110 may display a determination button for a user to determine whether or not to adopt the GCP on the display device 216.

The GCP setting unit 110 includes a line segment image conversion unit 110A, a feature point extraction unit 110B, and a reliability degree calculation unit 110C.

The line segment image conversion unit 110A extracts a line segment from the GCP setting image, and converts the GCP setting image into a line segment image. The extraction of the line segment is performed by, for example, performing differential processing on the GCP setting image. The line segment image is, for example, an image in which a contour of a road is extracted as a line segment from the GCP setting image.

The feature point extraction unit 110B extracts a feature point that is a target object for setting the GCP from a map corresponding to the imaging region of the GCP setting image in the map information acquired by the map information acquisition unit 104. The feature point is a point that is easily distinguished from a shape of another portion of the map, and is preferably a point having a unique shape. The feature point is, for example, a point at which an orientation of a contour of a road changes, a point at which contours of roads intersect, or a point at which a width of a road changes. Here, the feature point extraction unit 110B extracts a bending point of a road from the map. The bending point of the road is a point at which an orientation of a contour of the road changes, and is, for example, a corner of an intersection.

In addition, the feature point extraction unit 110B extracts a bending point from the line segment image converted by the line segment image conversion unit 110A.

The GCP setting unit 110 sets, for example, a bending point of a line segment image corresponding to the bending point of the road extracted from the map as the GCP.

The reliability degree calculation unit 110C calculates a reliability degree indicating how reliable the set GCP is as the GCP. The reliability degree calculation unit 110C may use road information region-extracted from the GCP setting image by artificial intelligence (AI), calculate how much two line segments that constitute the bending point that is the basis of the GCP and that are projected from the map information to the GCP setting image match a road end in the GCP setting image, and calculate a reliability degree that is relatively higher as the match is higher.

The reliability degree calculation unit 110C may calculate a reliability degree indicating how reliable the candidate position that is a candidate for the GCP is as the GCP. The GCP setting unit 110 may set the candidate position as the GCP in accordance with the reliability degree calculated by the reliability degree calculation unit 110C. The GCP setting unit 110 may display the reliability degree calculated by the reliability degree calculation unit 110C on the display device 216.

The tie point setting unit 112 sets the tie point in the image. The tie point is a point at the same location shown in two or more images. The tie point setting unit 112 automatically sets the tie point by the following (1) and (2) in general.

(1) Feature point extraction is performed on all images as a target. The images as the target are, for example, the plurality of images acquired by the captured image acquisition unit 100. For the feature point extraction, an existing feature point extraction method that is robust to rotation, enlargement, and reduction of the image is used. Examples of the existing feature point extraction method include speed up robust features (SURF) and accelerated KAZE (AKAZE).

(2) Feature point matching is performed between two images for all combinations of two images in all images as a target. The feature point matching is performed by calculating a similarity of a feature value corresponding to each of two feature points by an existing method.

As a result, a point at the same location shown in two or more images, that is, the tie point is obtained.

In the present embodiment, the tie point setting unit 112 particularly sets the GCP set in the overlap region with the GCP setting image in an image having the overlap region with the GCP setting image selected by the GCP setting image selection unit 106 among the plurality of images acquired by the captured image acquisition unit 100, as the tie point of the image. That is, in the present embodiment, the setting of the tie point is setting that the GCP set in one image is the same point in a case in which the GCP is shown in another image.

That is, the image processing apparatus 20 sets the GCP only for the tie point that can be reliably identified as the same target object in the image as the target object of the map information, instead of setting the GCP for all tie points that may be present in one image. As a result, accurate coordinates including a latitude, a longitude, and an elevation can be associated with the obtained tie point.

The SfM processing unit 114 performs SfM processing on the plurality of images acquired by the captured image acquisition unit 100 based on the tie point set by the tie point setting unit 112, and then calculates the position information and the posture information of the camera 14 at the time of imaging of each image. The SfM processing unit 114 may perform registration between the plurality of images acquired by the captured image acquisition unit 100 and the overall map corresponding to the imaging region, or may generate a three-dimensional model and an ortho image of the imaging region.

The input reception unit 116 receives an input from the input device 214. The display control unit 118 controls display on the display device 216.

### Image Processing Method: First Embodiment

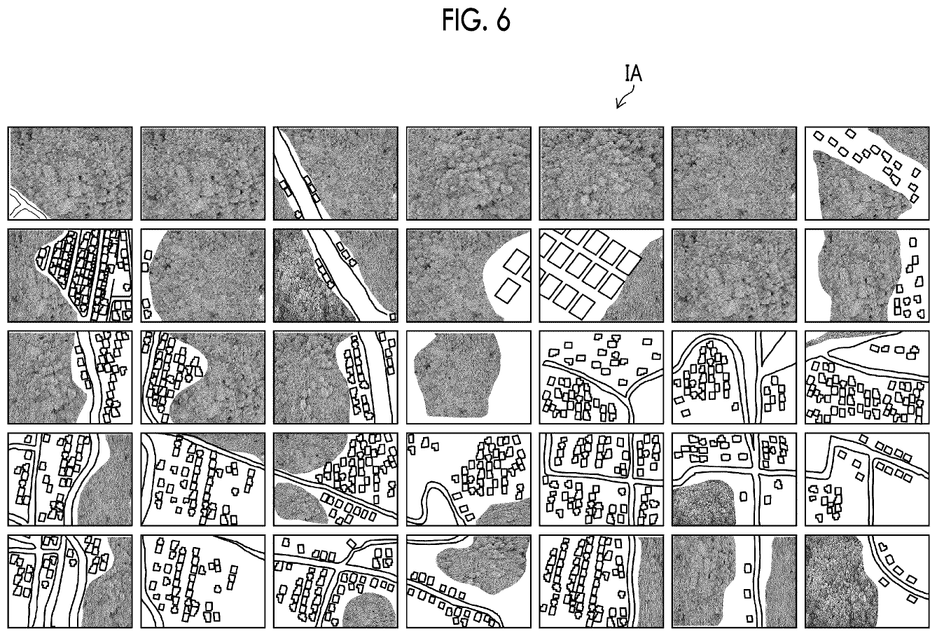

FIG. 5 is a flowchart showing each step of the image processing method according to the first embodiment. The image processing method automatically obtains a latitude, a longitude, and an elevation corresponding to a point in the image from a plurality of aerial images captured by using the drone 12, and thus it is possible to generate a high-accuracy three-dimensional model and an ortho image without performing the work of installing the aerial target marker and the work of setting the GCP by the person. The image processing method is implemented by the processor 202 executing an image processing program stored in the computer-readable medium 204. The image processing program may be provided by a non-transitory computer-readable storage medium, or may be provided via the network 22.

In step S1, the image processing apparatus 20 acquires the plurality of images.

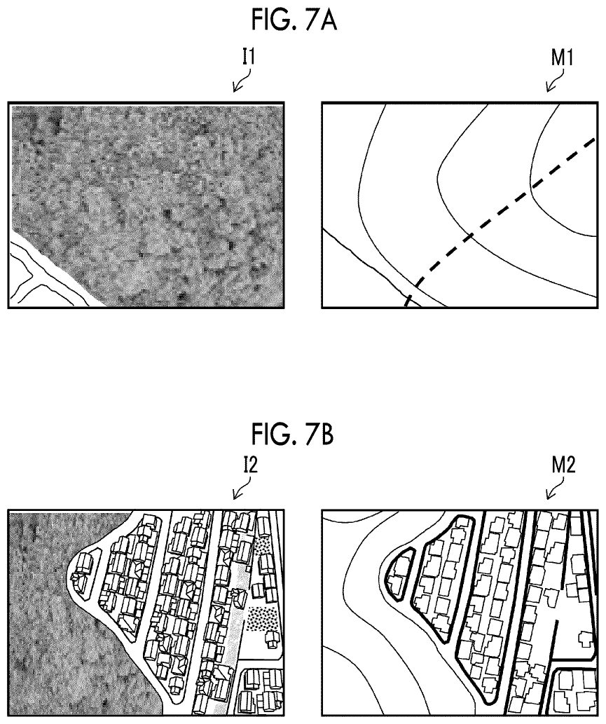

Here, the captured image acquisition unit 100 acquires a plurality of still images that are imaged with an overlap for a certain imaging region in one flight of the drone 12, and that are imaged with a part of the imaging region. FIG. 6 is an example of a plurality of images IA acquired by the captured image acquisition unit 100. FIG. 6 shows each image of the plurality of images IA by disposing the images in correspondence with the position of the imaging region of each image. Here, the certain imaging region is imaged in 35 images of 5 images in the vertical direction and 7 images in the horizontal direction, but the number of images is optional.

In step S2, the image processing apparatus 20 calculates the number of features shown in each image of the plurality of images acquired in step S1.

In order to calculate the number of features, first, the imaging condition acquisition unit 102 acquires the imaging condition of each image of the plurality of images. In addition, the GCP setting image selection unit 106 calculates an imaging range of each image based on the imaging condition of each image. Further, the map information acquisition unit 104 acquires a Geospatial Information Authority of Japan map corresponding to the calculated imaging range of each image. Then, the feature number calculation unit 106B calculates a rough number of buildings shown in each image based on the acquired Geospatial Information Authority of Japan map.

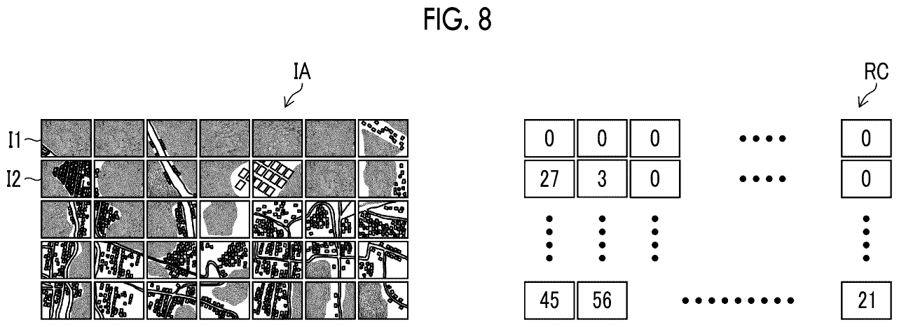

FIGS. 7A and 7B are diagrams showing images included in the plurality of images IA and a Geospatial Information Authority of Japan map corresponding to the image. FIG. 7A shows an image I1 of the plurality of images IA and a map M1 corresponding to the image I1. There is no building in the map M1. Therefore, the number of buildings shown in the image I1 is calculated as “0”. In addition, FIG. 7B shows an image I2 of the plurality of images IA and a map M2 corresponding to the image I2. There are 27 buildings in the map M2. Therefore, the number of buildings shown in the image I2 is calculated as “27”.

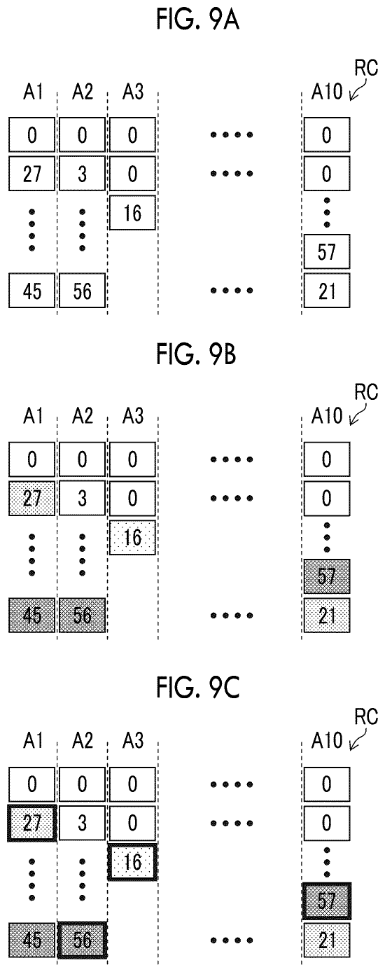

FIG. 8 is a diagram showing the plurality of images IA and a calculation result RC of the number of buildings. FIG. 8 shows each image of the plurality of images IA by disposing the images in correspondence with the position of the imaging region of each image. In addition, FIG. 8 shows the calculation result RC of each image by disposing the calculation results in correspondence with the position of each image. That is, the calculation result RC shown in FIG. 8 shows a two-dimensional distribution of the number of buildings of the imaging region of the plurality of images IA in general, although the buildings in the overlap region are redundantly calculated.

In step S3, the image processing apparatus 20 selects the GCP setting image.

The user may manually select the GCP setting image, but here, the GCP setting image selection unit 106 selects the GCP setting image from the plurality of images acquired in step S1. The GCP setting image selection unit 106 selects the GCP setting image from an image including a certain number or more of buildings by using the calculation result RC calculated in step S2. Here, the GCP setting image selection unit 106 selects the GCP setting image as evenly as possible across the imaging region (avoiding spatial bias). For example, the GCP setting image selection unit 106 divides the imaging region into a plurality of setting image selection regions, and selects one GCP setting image from each setting image selection region to select the GCP setting image evenly.

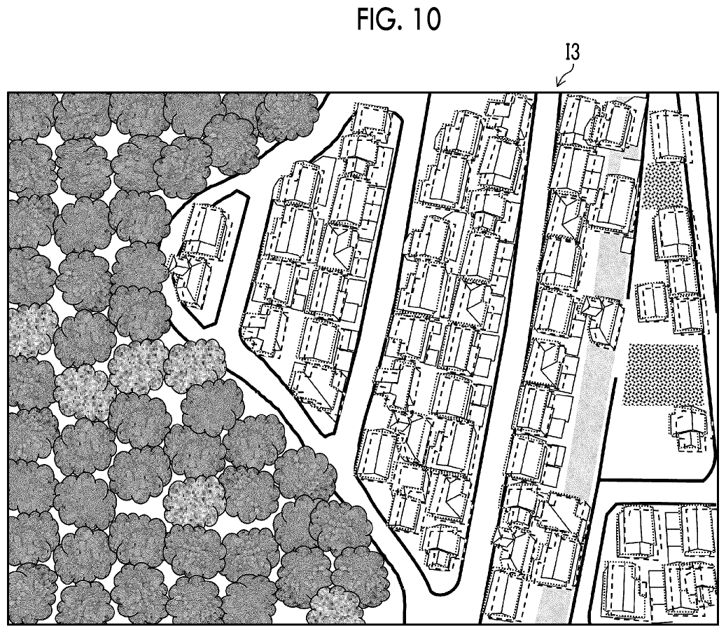

FIGS. 9A to 9C are diagrams for describing processing of selecting a GCP setting image. Here, the description will be made by using the calculation result RC showing the distribution of the number of buildings of the imaging region of the plurality of images IA.

First, the region division unit 106A divides the imaging region of the plurality of images IA into 10 setting image selection regions (hereinafter, referred to as areas). FIG. 9A shows an example of each area A1, A2, A3, A4, . . . , A9, and A10 in which the entire calculation result RC corresponding to the imaging region is divided into 10. Here, each area is a vertically long region, but the shape of each area A1 to A10 is not limited. It is preferable that each area A1 to A10 is a region in which the imaging region is evenly divided.

The feature number calculation unit 106B selects an image having the largest number of buildings (image ranked first in the number of buildings), an image having the second largest number of buildings (image ranked second in the number of buildings), and an image having the third largest number of buildings (image ranked third in the number of buildings) for each area A1 to A10, respectively. FIG. 9B shows the image selected by the GCP setting image selection unit 106 by hatching. In FIG. 9B, the image having the largest number of buildings is shown by the darkest hatching, the image having the second largest number of buildings is shown by the second darkest hatching, and the image having the third largest number of buildings is shown by the third darkest hatching.

Subsequently, the GCP setting image selection unit 106 selects one GCP setting image from three images having the first to third largest number of buildings for each area A1 to A10. By selecting one image from three images for each of the 10 areas, 3 to the power of 10 combinations occur. The image processing apparatus 20 selects the most uniform combination based on an index of “uniformity of image selection in the imaging region”.

FIG. 9C shows the GCP setting image finally selected. In FIG. 9C, the selected GCP setting image is shown by a thick frame. As described above, the GCP setting image of the region having a relatively large number of buildings is selected so as not to be biased in terms of location.

Here, the 10 GCP setting images are selected by dividing the imaging region of the plurality of images IA into 10 areas, but the number of GCP setting images is not limited to 10.

Next, in step S4, the image processing apparatus 20 applies geocoding to the GCP setting image selected in step S3, and performs registration between the GCP setting image and the map information acquired in step S2. Here, the geocoding application unit 108 projects (superimposes) the road line segment of the map information onto the GCP setting image.

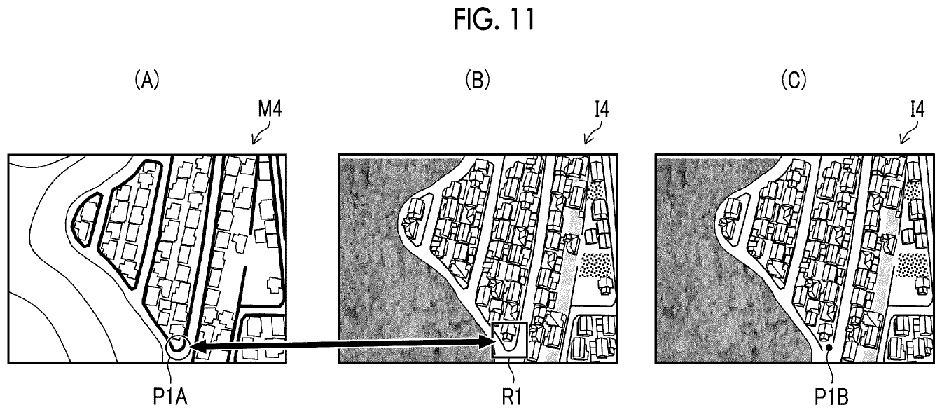

FIG. 10 is a diagram showing an application result of geocoding of the GCP setting image I3. In FIG. 10, the solid line projected onto the GCP setting image I3 is a road line segment of the map information. In addition, in FIG. 10, the broken line projected onto the GCP setting image I3 is a building ground contour of the map information, and the dotted line projected onto the GCP setting image I3 is a building roof contour at a height of 6 meters from the ground. Here, the solid line, the broken line, and the dotted line are projected onto the GCP setting image I3 with an accuracy of about within an error of 3 to 5 meters.

In step S5, the image processing apparatus 20 automatically extracts the GCP from the GCP setting image.

In order to automatically extract the GCP, first, the feature point extraction unit 110B specifies the map information corresponding to the GCP setting image, and extracts the bending point of the road from the map. The image of the region having a relatively large number of buildings is selected as the GCP setting image. Therefore, it is assumed that the GCP setting image includes a relatively large number of roads, and it is further assumed that the GCP setting image includes a relatively large number of bending points of the road. (A) to (C) of FIG. 11 are diagrams for describing extraction of the GCP. (A) of FIG. 11 is a diagram showing a map M4 corresponding to the GCP setting image I4. As shown in (A) of FIG. 11, a bending point P1A of the road is extracted from the map M4.

Next, the feature point extraction unit 110B searches for a point at a position corresponding to the position of the bending point P1A from the GCP setting image I4. (B) of FIG. 11 is a diagram showing a search range of the GCP setting image I4. As shown in (B) of FIG. 11, a search range R1 of a point corresponding to the bending point P1A is set in the GCP setting image I4. The search range R1 is, for example, a rectangular range of about 5 meters in both the vertical and horizontal directions centered on a point obtained by projecting the bending point by geocoding.

Here, the line segment image conversion unit 110A converts the GCP setting image I4 into a line segment image. The feature point extraction unit 110B extracts the bending point from the line segment image, and obtains the bending point corresponding to the bending point P1A extracted from the map M4. (C) of FIG. 11 is a diagram showing a point P1B of the GCP setting image I4 corresponding to the bending point P1A of the map M4. An image coordinate of the point P1B corresponds to a map coordinate of the bending point P1A. The map coordinate includes a latitude, a longitude, and an elevation.

In a case in which a plurality of GCPs are obtained from one image, the GCP setting unit 110 may select one GCP having the highest reliability degree calculated by the reliability degree calculation unit 110C among the plurality of GCPs.

The image processing apparatus 20 performs the processing of step S4 and step S5 on each of the 10 GCP setting images selected in step S3.

Finally, in step S6, the image processing apparatus 20 displays a GCP check/correction screen on the display device 216. The user can check and correct the automatically extracted GCP by the GCP check/correction screen.

According to the image processing method according to the first embodiment, the GCP can be set in the image without performing the work of installing the aerial target marker and the work of setting the GCP by the person, and a high-accuracy three-dimensional model and an ortho image can be generated.

In the first embodiment, the GCP setting image is selected evenly from the imaging region, and the feature point that is a target object suitable as the GCP is extracted from the setting image and set as the GCP. In a case of a disaster damage determination survey for disaster proof of natural disasters, a house is a survey target, and thus a residential area is often set as the imaging target. In this case, it is expected that a target object suitable as the GCP is sufficiently included in any image. Therefore, the selection of the GCP setting image is relatively important.

On the other hand, in a case in which a forest area or a place with many rice paddies and fields is set as the imaging target, the scarcity value of the target object suitable as the GCP is relatively high. In this case, first, the feature point that is the target object suitable as the GCP may be extracted, and the image including the target object may be acquired as the GCP setting image. That is, the target object suitable as the GCP may be set as the GCP, and the GCP may be as evenly dispersed as possible.

### Example of GCP Check/Correction Screen

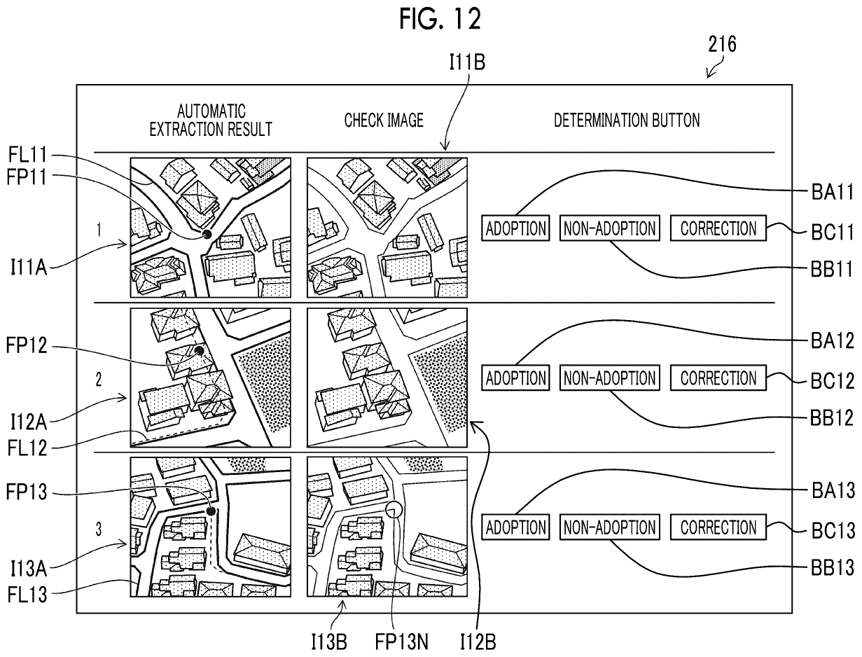

FIG. 12 is a diagram showing an example of the GCP check/correction screen. Here, an example of checking or correcting three GCPs from the first to the third is shown. The check or correction of the remaining GCPs from the fourth can be performed by scrolling the screen or transitioning the screen by the input device 214. The number of GCPs displayed at once and the display order of the GCPs are not particularly limited.

As shown in FIG. 12, on the GCP check/correction screen, an automatic extraction result, a check image, and a determination button are displayed for each GCP.

In the upper part of the display screen shown in FIG. 12, an image I11A as an automatic extraction result of the first GCP and an image I11B as a check image of the first GCP are displayed side by side with the same size.

The image I11B is an image in which the GCP setting image is enlarged and cut out with the position of the automatically extracted GCP as a center. The image I11B may be the GCP setting image itself. The image I11A is an image in which a point figure FP11 and a line figure FL11 are superimposed on the same image as the image I11B. The point figure FP11 is superimposed on the position of the automatically extracted GCP, and the line figure FL11 is superimposed on the position of the contour of the road extracted from the map information. It is preferable that the point figure FP11 and the line figure FL11 are displayed in a color that is easily visible when superimposed on the image. For example, the point figure FP11 is displayed in green, and the line figure FL11 is displayed in blue.

The user can check whether or not the position of the point figure FP11 superimposed on the image I11A is the position of the bending point of the road of the image I11B, that is, whether or not the position of the automatically extracted GCP is appropriate by comparing the displayed images I11A and I11B.

In addition, in the upper part of the display screen shown in FIG. 12, an adoption button BA11, a non-adoption button BB11, and a correction button BC11, which are graphical user interface (GUI) buttons, are disposed as the determination buttons of the first GCP. The adoption button BA11, the non-adoption button BB11, and the correction button BC11 can be selected by the user by using the input device 214. The selection operation is, for example, a click operation after moving a mouse cursor to a desired set area.

In a case in which the adoption button BA11 is selected, the automatically extracted GCP is adopted. In a case in which the non-adoption button BB11 is selected, the automatically extracted GCP is not adopted. In a case in which the correction button BC11 is selected, the position of the automatically extracted GCP can be corrected.

For example, the position of the point figure FP11 is not a problem as the GCP. Therefore, the user can adopt the first GCP by selecting the adoption button BA11. That is, the GCP is set at the position of the point figure FP11 superimposed on the image I11A.

In addition, in the middle part of the display screen shown in FIG. 12, an image I12A as an automatic extraction result of the second GCP and an image I12B as a check image of the second GCP are displayed side by side with the same size.

The image I12B is an image in which the GCP setting image is enlarged and cut out with the position of the automatically extracted GCP as a center. The image I12A is an image in which a point figure FP12 and a line figure FL12 are superimposed on the same image as the image I12B. The point figure FP12 is superimposed on the position of the automatically extracted GCP, and the line figure FL12 is superimposed on the position of the contour of the road of the map information.

In addition, in the middle part of the display screen shown in FIG. 12, an adoption button BA12, a non-adoption button BB12, and a correction button BC12 are disposed as the determination buttons of the second GCP.

The position of the point figure FP12 is good in terms of position, but is a position of a road hidden in a shadow of a building, and thus is not preferable as the GCP. Therefore, the user can non-adopt the second GCP by selecting the non-adoption button BB12. That is, the GCP is not set at the position of the point figure FP12 superimposed on the image I12A.

Similarly, in the lower part of the display screen shown in FIG. 12, an image I13A as an automatic extraction result of the third GCP and an image I13B as a check image of the third GCP are displayed side by side with the same size.

The image I13B is an image in which the GCP setting image is enlarged and cut out with the position of the automatically extracted GCP as a center. The image I13A is an image in which a point figure FP13 and a line figure FL13 are superimposed on the same image as the image I13B. The point figure FP13 is superimposed on the position of the automatically extracted GCP, and the line figure FL13 is superimposed on the position of the contour of the road of the map information.

In addition, in the lower part of the display screen shown in FIG. 12, an adoption button BA13, a non-adoption button BB13, and a correction button BC13 are disposed as the determination buttons of the third GCP.

The point figure FP13 is at a position deviated from the position of the road, and thus is not preferable as the GCP. In such a case, the user can correct the position of the point figure FP13 by selecting the correction button BC13. The position of the point figure FP13 is corrected by the user designating a correct position on the check image by using the input device 214. In the example shown in FIG. 12, in the image I13B, a position after correction is designated by a circular figure FP13N. It is preferable that the circular figure FP13N is displayed in a color that is easily visible when superimposed on the image, and for example, the circular figure FP13N is displayed in yellow.

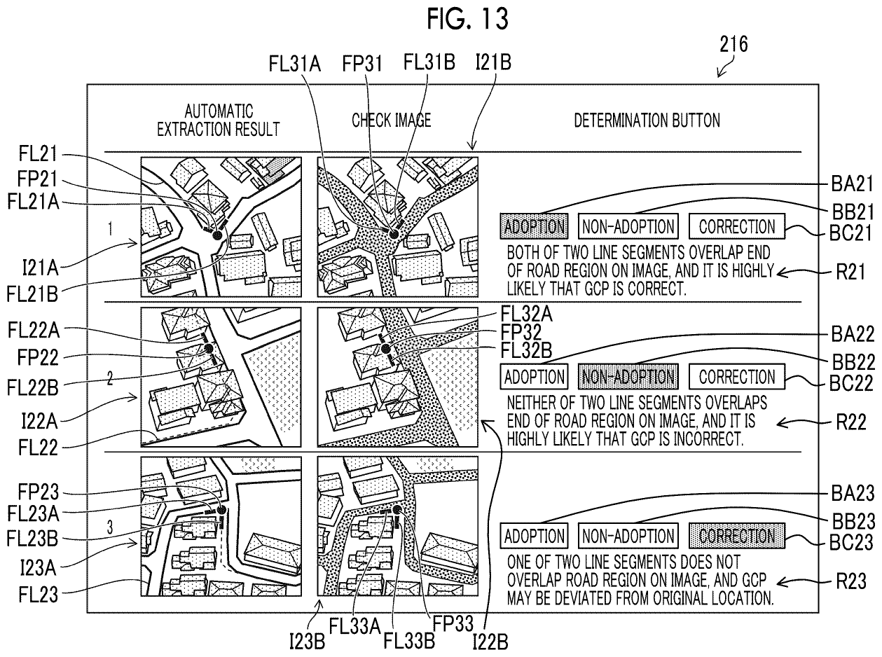

FIG. 13 is a diagram showing another example of the GCP check/correction screen. As in the example shown in FIG. 12, an example of checking or correcting three GCPs is shown. On the GCP check/correction screen, an automatic extraction result, a check image, and a determination result are displayed for each GCP.

In the upper part of the display screen shown in FIG. 13, an image I21A as an automatic extraction result of the first GCP and an image I21B as a check image of the first GCP are displayed side by side with the same size.

The image I21B is an image in which a region of the road extracted from the image is displayed, for example, in yellow in the image in which the GCP setting image is enlarged and cut out with the position of the automatically extracted GCP as a center. Further, in the image I21B, a point figure FP31 is superimposed on the position of the automatically extracted GCP, and a line figure FL31A and a line figure FL31B are superimposed on two line segments constituting the bending point of the GCP, respectively.

A color to be displayed for the line figure FL31A and the line figure FL31B is determined depending on whether or not the figures overlap an end of the road region. In the image I21B, since the line figure FL31A and the line figure FL31B each overlap the end of the road region, for example, the figures are displayed in green. Accordingly, the point figure FP31 is also displayed in green.

The image I21A is an image in which a point figure FP21, a line figure FL21, a line figure FL21A, and a line figure FL21B are superimposed on the image in which the GCP setting image is enlarged and cut out with the position of the automatically extracted GCP as a center. The line figure FL21 is superimposed on the position of the contour of the road extracted from the map information. The positions at which the point figure FP21, the line figure FL21A, and the line figure FL21B are superimposed are the same as the positions of the point figure FP31, the line figure FL31A, and the line figure FL31B of the image I21B, respectively.

The line figure FL21 is displayed in, for example, blue. In addition, colors of the point figure FP21, the line figure FL21A, and the line figure FL21B are determined in accordance with the reliability degree of the GCP, and are the same as the colors of the point figure FP31, the line figure FL31A, and the line figure FL31B of the image I21B, respectively.

The user can check whether or not the position of the point figure FP21 superimposed on the image I21A is appropriate as the GCP by comparing the displayed images I21A and I21B.

In addition, in the upper part of the display screen shown in FIG. 13, an adoption button BA21, a non-adoption button BB21, and a correction button BC21 are disposed as the determination buttons of the first GCP. Among the adoption button BA21, the non-adoption button BB21, and the correction button BC21, any one of the buttons is selected in advance in accordance with the reliability degree of the automatically extracted GCP. Here, the reliability degree of the GCP of the image I21A is relatively high. Therefore, the adoption button BA21 is selected in advance. The button selected in advance is displayed in a color different from the unselected button. Here, the unselected non-adoption button BB21 and the correction button BC21 are displayed in, for example, white, and the adoption button BA21 selected in advance is displayed in, for example, red.

Further, a reason R21 for the advance selection of the first GCP is displayed below the adoption button BA21, the non-adoption button BB21, and the correction button BC21. Here, as the reason R21, “both of the two line segments overlap the end of the road region on the image, and it is highly likely that the GCP is correct” is displayed. The user can know the reason why the adoption button BA21 is selected in advance by the reason R21.

In the middle part of the display screen shown in FIG. 13, an image I22A as an automatic extraction result of the second GCP and an image I22B as a check image of the second GCP are displayed side by side with the same size.

The image I22B is an image in which a region of the extracted road is displayed in yellow in the image in which the GCP setting image is enlarged and cut out with the position of the automatically extracted GCP as a center. Further, in the image I22B, a point figure FP32 is superimposed on the position of the automatically extracted GCP, and a line figure FL32A and a line figure FL32B are superimposed on two line segments constituting the bending point of the GCP, respectively.

In the image I22B, since the line figure FL32A and the line figure FL32B do not overlap the end of the road region, for example, the figures are displayed in red. Accordingly, the point figure FP32 is also displayed in red.

The image I22A is an image in which a point figure FP22, a line figure FL22, a line figure FL22A, and a line figure FL22B are superimposed on the image in which the GCP setting image is enlarged and cut out with the position of the automatically extracted GCP as a center. The line figure FL22 is superimposed on the position of the contour of the road of the map information. The positions at which the point figure FP22, the line figure FL22A, and the line figure FL22B are superimposed are the same as the positions of the point figure FP31, the line figure FL31A, and the line figure FL31B of the image I22B, respectively.

The line figure FL22 is displayed in, for example, blue. In addition, colors of the point figure FP22, the line figure FL22A, and the line figure FL22B are determined in accordance with the reliability degree of the GCP, and are the same as the colors of the point figure FP32, the line figure FL32A, and the line figure FL32B of the image I22B, respectively.

In addition, in the middle part of the display screen shown in FIG. 13, an adoption button BA22, a non-adoption button BB22, and a correction button BC22 are disposed as the determination buttons of the second GCP. Here, since the reliability degree of the GCP of the image I22A is relatively low, the non-adoption button BB22 is selected in advance. The non-adoption button BB22 selected in advance is displayed in, for example, red.

Further, a reason R22 for the advance selection of the second GCP is displayed below the adoption button BA22, the non-adoption button BB22, and the correction button BC22. Here, as the reason R22, “neither of the two line segments overlaps the end of the road region on the image, and it is highly likely that the GCP is incorrect” is displayed. The user can know the reason why the non-adoption button BB22 is selected in advance by the reason R22.

In the lower part of the display screen shown in FIG. 13, an image I23A as an automatic extraction result of the third GCP and an image I23B as a check image of the third GCP are displayed side by side with the same size.

The image I23B is an image in which a region of the extracted road is displayed in yellow in the image in which the GCP setting image is enlarged and cut out with the position of the automatically extracted GCP as a center. Further, in the image I23B, a point figure FP33 is superimposed on the position of the automatically extracted GCP, and a line figure FL33A and a line figure FL33B are superimposed on two line segments constituting the bending point of the GCP, respectively.

In the image I23B, since the line figure FL33A overlaps the end of the road region, the line figure FL33A is displayed in green. On the other hand, since the line figure FL33B does not overlap the end of the road region, the line figure FL33B is displayed in red. Accordingly, the point figure FP33 is displayed in, for example, orange.

The image I23A is an image in which a point figure FP23, a line figure FL23, a line figure FL23A, and a line figure FL23B are superimposed on the image in which the GCP setting image is enlarged and cut out with the position of the automatically extracted GCP as a center. The line figure FL23 is superimposed on the position of the contour of the road of the map information. The positions at which the point figure FP23, the line figure FL23A, and the line figure FL23B are superimposed are the same as the positions of the point figure FP33, the line figure FL33A, and the line figure FL33B of the image I23B, respectively.

The line figure FL23 is displayed in, for example, blue. In addition, colors of the point figure FP23, the line figure FL23A, and the line figure FL23B are determined in accordance with the reliability degree of the GCP, and are the same as the colors of the point figure FP33, the line figure FL33A, and the line figure FL33B of the image I23B, respectively.

In addition, in the lower part of the display screen shown in FIG. 13, an adoption button BA23, a non-adoption button BB23, and a correction button BC23 are disposed as the determination buttons of the third GCP. Here, since the reliability degree of the GCP of the image I23A is relatively medium, the correction button BC23 is selected in advance. The correction button BC23 selected in advance is displayed in, for example, red.

Further, a reason R23 for the advance selection of the second GCP is displayed below the adoption button BA23, the non-adoption button BB23, and the correction button BC23. Here, as the reason R23, “one of the two line segments does not overlap the road region on the image, and the GCP may be deviated from the original location” is displayed. The user can know the reason why the correction button BC23 is selected in advance by the reason R23.

Here, the image processing apparatus 20 determines the color of the point figure and the color of the line figure in accordance with the reliability degree of the GCP, but the shape of the point figure and the line type of the line figure may be changed in accordance with the reliability degree of the GCP. The image processing apparatus 20 may perform blinking display of the point figure and the line figure. The image processing apparatus 20 may display a pop-up of an enlarged image of the position of the GCP in a case in which the user brings a cursor close to the point figure indicating the position of the GCP. The image processing apparatus 20 may display the reliability degree of the GCP on the GCP check/correction screen.

The image processing apparatus 20 may display the map corresponding to the GCP setting image in accordance with an orientation and an angle of the GCP setting image. The map in this case may be a Geospatial Information Authority of Japan map or another map.

### Image Processing Method: Second Embodiment

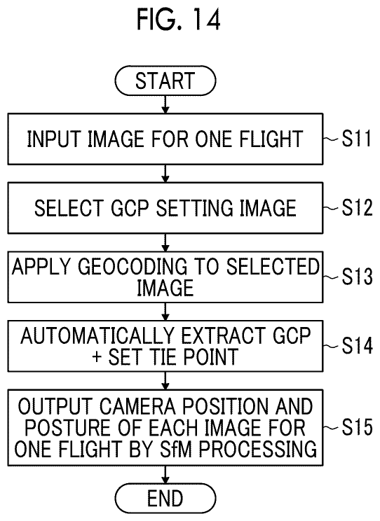

FIG. 14 is a flowchart showing each step of the image processing method according to the second embodiment.

In step S11, the image processing apparatus 20 acquires a plurality of images that are imaged with an overlap for a certain imaging range in one flight of the drone 12. This step is the same as step S1 of FIG. 5.

Subsequently, in step S12, the image processing apparatus 20 selects the GCP setting image. This step is the same as steps S2 and S3 of FIG. 5. For example, 10 GCP setting images are selected so as not to be biased in terms of location.

In addition, in step S13, the image processing apparatus 20 applies geocoding to the GCP setting image selected in step S12, and performs registration between the GCP setting image and the map. This step is the same as step S4 of FIG. 5. The registration between the GCP setting image and the map may be performed by a method different from geocoding.

In step S14, the image processing apparatus 20 automatically extracts the GCP from the GCP setting image, and sets the tie point. The step of automatically extracting the GCP is the same as step S5 of FIG. 5.

In addition, the tie point setting unit 112 sets the tie point. The tie point setting unit 112 sets the tie point in an image having an overlap region with the GCP setting image selected in step S12 among the plurality of images acquired in step S11, and associates the accurate coordinates with the set tie point.

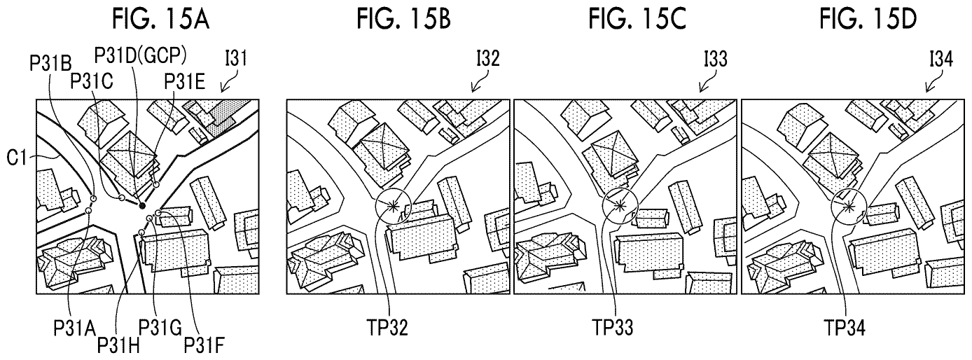

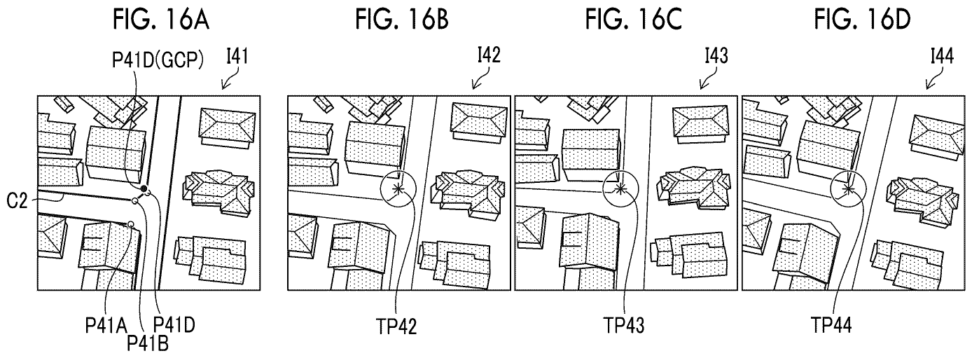

FIGS. 15A to 16D are diagrams for describing the automatic extraction of the GCP and the setting of the tie point. FIG. 15A shows an enlarged image I31 of the GCP setting image. In FIG. 15A, a contour C1 of the road extracted from the map information, a bending point P31A of the road, a bending point P31B of the road, a bending point P31C of the road, a bending point P31D of the road, a bending point P31E of the road, a bending point P31F of the road, a bending point P31G of the road, and a bending point P31H of the road are shown. Here, it is assumed that the bending point P31D is automatically extracted as the GCP.

FIG. 15B shows an enlarged image I32 of an image in which the bending point P31D is shown in addition to the GCP setting image among the plurality of images acquired in step S11. A tie point TP32 is set in the enlarged image I32.

Similarly, FIGS. 15C and 15D show enlarged images I33 and I34 of images in which the bending point P31D is shown in addition to the GCP setting image among the plurality of images acquired in step S11, respectively. A tie point TP33 and a tie point TP34 are set in the enlarged image I33 and the enlarged image I34, respectively.

Coordinates are associated with the tie point TP32, the tie point TP33, and the tie point TP34, respectively. However, these coordinates are calculated based on the camera position and the posture obtained from the sensor data of the camera 14 at the time of imaging, and are not necessarily accurate.

On the other hand, since the contour C1 of the road of FIG. 15A is extracted from the map information, the accurate coordinates (latitude, longitude, and elevation) of the bending points P31A to P31H on the contour C1 of the road are known. Therefore, a point on the contour C1 of the road corresponding to the tie point TP32, the tie point TP33, and the tie point TP34 is searched for, and the accurate coordinates are associated with the tie point TP32, the tie point TP33, and the tie point TP34. In the example of FIGS. 15A to 15C, the points corresponding to the tie point TP32, the tie point TP33, and the tie point TP34 are the bending point P31D, and the accurate coordinates of the bending point P31D are associated with the tie point TP32, the tie point TP33, and the tie point TP34.

FIG. 16A shows an enlarged image I41 of the GCP setting image. In FIG. 16A, a contour C2 of the road extracted from the map information, a bending point P41A of the road, a bending point P41B of the road, and a bending point P41C of the road are shown. Here, it is assumed that the bending point P41C is automatically extracted as the GCP.

FIG. 16B shows an enlarged image I42 of an image in which the bending point P41C is shown in addition to the GCP setting image among the plurality of images acquired in step S11. A tie point TP42 is set in the enlarged image I42.

Similarly, FIGS. 16C and 16D show enlarged images I43 and I44 of images in which the bending point P41C is shown in addition to the GCP setting image among the plurality of images acquired in step S11, respectively. A tie point TP43 and a tie point TP44 are set in the enlarged image I43 and the enlarged image I44, respectively.

Coordinates having low accuracy are associated with the tie point TP42, the tie point TP43, and the tie point TP44, respectively. Therefore, a point on the contour C2 of the road corresponding to the tie point TP42, the tie point TP43, and the tie point TP44 is searched for, and the accurate coordinates are associated with the tie point TP42, the tie point TP43, and the tie point TP44. In the example of FIGS. 16A to 16D, the points corresponding to the tie point TP42, the tie point TP43, and the tie point TP44 are the bending point P41C, and the accurate coordinates of the bending point P41C are associated with the tie point TP42, the tie point TP43, and the tie point TP44.

Finally, in step S15, the image processing apparatus 20 outputs the camera position and the posture of each image for one flight by the SfM processing. Here, the SfM processing unit 114 performs the SfM processing on each image acquired in step S11 based on the tie point set in step S14, and calculates the position information of the camera 14 and the posture information of the camera 14 at the time of imaging of each image.

In a case in which the automatic extraction of the GCP is performed on 445 images obtained by imaging a 500 m square imaging region, the tie point setting is semi-automatically performed by inputting the automatically extracted GCP to a commercially available software of Pix4D (registered trademark), and the processing of step S15 is performed, the required time is about 44 minutes.

As a result of evaluating the accuracy based on the position information and the posture information of the camera 14 obtained in this way, the accuracy is significantly improved from 92.7% in geocoding to 99.6%. As described above, it is confirmed that the same accuracy as that in a case in which the SfM processing is performed after the GCP is set by the person is obtained.

The “accuracy” is calculated as follows.

First, the image and the map are superimposed on each other by geocoding and each of the embodiments. In order to perform the registration between the image and the map, it is necessary to obtain the position and the posture of the camera.

In a case of geocoding, the line segment extracted from the image and the line segment extracted from the map are matched to each other to obtain the position and the posture of the camera. The geocoding is performed for each image.

In the present embodiment, the SfM processing is performed after the GCP is obtained. The SfM processing generally uses several hundred images with a large overlap region. The tie point is obtained by performing the feature extraction from the image and the matching between the features, and the position and the posture of the camera are obtained based on the tie point. By setting the GCP, that is, the latitude, the longitude, and the elevation that are correct coordinates for some of the tie points, the position and the posture of the camera can be accurately obtained.

Next, the “success” or the “failure” of the superimposition is determined for each building in the image.

In order to perform the determination, first, a correct answer frame surrounding an evaluation target building in the image is set in the image in advance. Next, based on the result of superimposing the image and the map by using the geocoding, a first frame of the building outer periphery of the map is set in the image. The building in which the overlap between the correct answer frame and the first frame is 80% or more is defined as the “success” in the geocoding.

Similarly, based on the result of superimposing the image and the map by using the present embodiment, a second frame of the building outer periphery of the map is set in the image. The building in which the overlap between the correct answer frame and the second frame is 80% or more is defined as the “success” in the present embodiment.

Then, in a case in which the number of buildings in all images is an integer N and the number of buildings of the “success” is an integer M, M/N is the success rate, that is, the “accuracy”.

In a case in which the same building is shown in a plurality of images, the evaluation target building is treated as a separate building. In addition, since there is a “building that exists on the map but does not exist on the site”, the number of buildings N in all images is “buildings that exist on the map among the buildings in all images” in fact.

According to the image processing method according to the second embodiment, the GCP and the tie point are automatically set in the image, so that it is possible to generate a high-accuracy three-dimensional model and an ortho image without performing the work of installing the aerial target marker and the work of setting the GCP by the person.

### Others

The technical scope of the present invention is not limited to the scope described in the above-described embodiments. The configuration and the like in each embodiment can be combined between the embodiments as appropriate without departing from the gist of the present invention.

### Explanation of References

10: captured image processing system
12: drone
13: gimbal head
14: camera
16: remote controller
16A: display
20: image processing apparatus
22: network
30: GPS receiver
32: atmospheric pressure sensor
34: azimuth sensor
36: gyro sensor
38: motor
40: processor
42: storage device
44: communication interface
100: captured image acquisition unit
102: imaging condition acquisition unit
104: map information acquisition unit
106: GCP setting image selection unit
106A: region division unit
106B: feature number calculation unit
108: geocoding application unit
110: GCP setting unit
110A: line segment image conversion unit
110B: feature point extraction unit
110C: reliability degree calculation unit
112: tie point setting unit
114: SfM processing unit
116: input reception unit
118: display control unit
202: processor
204: computer-readable medium
206: communication interface
208: input/output interface
210: bus
214: input device
216: display device
A1: area
A2: area
A3: area
A4: area
A5: area
A6: area
A7: area
A8: area
A9: area
A10: area
BA11: adoption button
BA12: adoption button
BA13: adoption button
BA21: adoption button
BA22: adoption button
BA23: adoption button
BB11: non-adoption button
BB12: non-adoption button
BB13: non-adoption button
BB21: non-adoption button
BB22: non-adoption button
BB23: non-adoption button
BC11: correction button
BC12: correction button
BC13: correction button
BC21: correction button
BC22: correction button
BC23: correction button
C1: contour of road
C2: contour of road
FL11: line figure
FL12: line figure
FL13: line figure
FL21: line figure
FL21A: line figure
FL21B: line figure
FL22: line figure
FL22A: line figure
FL22B: line figure
FL23: line figure
FL23A: line figure
FL23B: line figure
FL31A: line figure
FL31B: line figure
FL32A: line figure
FL32B: line figure
FL33A: line figure
FL34B: line figure
FP11: point figure
FP12: point figure
FP13: point figure
FP13N: circular figure
FP21: point figure
FP22: point figure
FP23: point figure
FP31: point figure
FP32: point figure
FP33: point figure
I1: image
I2: image
I3: GCP setting image
I4: GCP setting image
I11A: image
I11B: image
I12A: image
I12B: image
I13A: image
I13B: image
I21A: image
I21B: image
I22A: image
I22B: image
I23A: image
I23B: image
I31: enlarged image
I32: enlarged image
I33: enlarged image
I34: enlarged image
I41: enlarged image
I42: enlarged image
I43: enlarged image
I44: enlarged image
IA: plurality of images
M1: map
M2: map
M4: map
P1A: bending point
P1B: point
P31A: bending point
P31B: bending point
P31C: bending point
P31D: bending point
P31E: bending point
P31F: bending point
P31G: bending point
P31H: bending point
P41A: bending point
P41B: bending point
P41C: bending point
R1: search range
R21: reason
R22: reason
R23: reason
RC: calculation result
S1 to S6: steps of image processing method
S11 to S15: steps of image processing method
TP32: tie point
TP33: tie point
TP34: tie point
TP42: tie point
TP43: tie point
TP44: tie point

What is claimed is:

1. An image processing apparatus comprising:
one or more processors; and
one or more memories that store a program to be executed by the one or more processors,
wherein the processor is configured to execute a command of the program to
acquire an image group in which a certain imaging region is imaged by using a camera,
select a setting image for setting a ground control point from the image group,
specify a map corresponding to an imaging region of the setting image,
specify a target object for setting the ground control point from the map,
search for a candidate position corresponding to a position of the target object from the setting image, and
set the candidate position as the ground control point.

2. The image processing apparatus according to claim 1, wherein the processor is configured to select a plurality of the setting images.

3. The image processing apparatus according to claim 2,
wherein the processor is configured to:
divide the imaging region into a plurality of setting image selection regions each including a plurality of images;
calculate the number of features in each image of the image group; and
select, for each setting image selection region of the plurality of setting image selection regions, an image having a relatively large number of features among the plurality of images included in the setting image selection region as the setting image.

4. The image processing apparatus according to claim 1,
wherein the target object is a bending point of a road.

5. The image processing apparatus according to claim 4,
wherein the processor is configured to:
extract the bending point of the road from the map;
convert the setting image into a line segment image;
extract a bending point as the candidate position from the line segment image; and
set the bending point of the line segment image corresponding to the bending point of the road as the ground control point.

6. The image processing apparatus according to claim 1,
wherein the processor is configured to display an extraction result image in which a figure is superimposed on a position of the ground control point of the setting image on a display device.

7. The image processing apparatus according to claim 6,
wherein the processor is configured to display an enlarged image in which a position of the ground control point of the setting image is enlarged on the display device.

8. The image processing apparatus according to claim 6,
wherein the processor is configured to:
display the extraction result image and a check image based on the setting image side by side on the display device; and
further display a determination button for a user to determine whether or not to adopt the ground control point on the display device.

9. The image processing apparatus according to claim 8,
wherein the processor is configured to:
calculate a reliability degree indicating how reliable the set ground control point is as the ground control point; and
display the reliability degree on the display device.

10. The image processing apparatus according to claim 1,
wherein the processor is configured to:
calculate a reliability degree indicating how reliable the candidate position is as the ground control point; and
set the candidate position as the ground control point in accordance with the reliability degree.

11. The image processing apparatus according to claim 1,
wherein the image group is captured with an overlapping region with an adjacent image, and
the processor is configured to:
set the ground control point set in the overlapping region as a tie point; and
calculate a position and an orientation of the camera in a case in which the camera captures each image of the image group based on the tie point.

12. The image processing apparatus according to claim 1,
wherein the processor is configured to:
acquire an overall map corresponding to the certain imaging region; and
perform registration between each image of the image group and the overall map by using the set ground control point.

13. An image processing method executed by one or more processors, the image processing method comprising:
acquiring an image group in which a certain imaging region is imaged by using a camera;
selecting a setting image for setting a ground control point from the image group;
specifying a map corresponding to an imaging region of the setting image;
specifying a target object for setting the ground control point from the map;
searching for a candidate position corresponding to a position of the target object from the setting image; and
setting the candidate position as the ground control point.

14. A non-transitory, computer-readable tangible recording medium on which a program is recorded, the program causing, when read by a computer, the computer to implement:
a function of acquiring an image group in which a certain imaging region is imaged by using a camera;
a function of selecting a setting image for setting a ground control point from the image group;
a function of specifying a map corresponding to an imaging region of the setting image;
a function of specifying a target object for setting the ground control point from the map;
a function of searching for a candidate position corresponding to a position of the target object from the setting image; and
a function of setting the candidate position as the ground control point.
